(19) United States
(12) Patent Application Publication
(10) Pub. No.: US 2026/0186158 A1
(43) Pub. Date: Jul. 2, 2026

(54) PRESSURE WAVE GENERATOR

(71) Applicant: P-WAVE AG, Waltenschwil (CH)

(72) Inventor: Hans RÜEGG, Waltenschwil (CH)

(21) Appl. No.: 18/727,919

(22) PCT Filed: Jan. 13, 2022
(86) PCT No.: PCT/EP2022/050620

§ 371 Date: Jul. 10, 2024

(51) Int. Cl. G01V 1/137; G10K 15/04

(52) U.S. Cl. CPC G01V 1/137; G10K 15/043

(57) ABSTRACT

A pressure wave generator (DWG) as well as a system and a method for generating a pressure wave, in particular for cleaning a vessel, e.g. a steam boiler or pipe, wherein the DWG includes a pressure chamber (11, 12), which can be filled with a working medium via a pressure chamber inlet, with at least two opposing pressure outlets (15), and furthermore an actuator chamber (18), which can be filled with an actuator medium via an actuator chamber inlet (5), and at least two opposing actuator outlets (8), which are connected to the pressure chamber (11, 12) by a passage. Furthermore, the DWG includes a closure element (13) in the pressure chamber (11, 12) which, in a closed position, closes the pressure chamber (11, 12) with respect to the pressure outlets (15) and, in an open position, allows the working medium to flow out through the pressure outlets (15). In addition, the DWG includes an actuator element (6) in the actuator chamber (18) which, in a closed position, closes the pressure chamber (11, 12) with respect to the actuator outlets (8) and, in an open position, allows the working medium to flow out through the passage (7) and the actuator outlets (8).

### CROSS-REFERENCE TO RELATED APPLICATION

This application is a National Stage application of International Patent Application No. PCT/EP2022/050620, filed on Jan. 13, 2022, which is hereby incorporated by reference in its entirety.

### TECHNICAL FIELD

The invention relates to a pressure wave generator (DWG) and a system for generating a pressure wave, as well as a method for generating a pressure wave and a use of the DWG, system or method.

### BACKGROUND

DWGs can be used to clean a dirty tank, pipe or steam boiler, e.g. in a power plant. Such a DWG is described, for example, in WO 2021/078754 A1. Compressed air is forced into a pressure chamber, e.g. at 100 bar. When the air suddenly flows out of the pressure chamber, a very fast air flow is generated, which creates a strong pressure wave with high total pressure in the vicinity of the DWG. When this pressure wave hits the contaminated surfaces of the tank, pipe or steam boiler, it exerts a strong force on the existing contaminants, e.g. deposits and caking, and blasts them away.

Known DWGs have various disadvantages: On the one hand, they have a large form factor due to the volumes of compressed air required and a high weight, particularly in the range of several hundred kilograms. As a result, such DWGs can hardly be used for mobile applications and in particular cannot be maneuvered by hand, and they cannot be brought into the room that is to be cleaned. On the other hand, some of the potential energy stored with the compressed air in the DWG is dissipated either inside the DWG, e.g. by impacts on the walls of the pressure chamber, or outside due to the undirected propagation of the pressure wave, e.g. in directions in which there is no contamination.

### SUMMARY

There is therefore a need for an improved pressure wave generator (DWG). One possible object of the invention is to provide a DWG that can be maneuvered by hand and, in particular, can also be used in places that are difficult to access. Another possible object of the invention is to provide a DWG with an increased cleaning effect. Furthermore, an object of the invention can be seen in providing a correspondingly improved method for generating a pressure wave.

### Pressure Wave Generator

One or more of the above problems are solved by the DWG according to the invention, which is designed to generate a pressure wave in the environment of the DWG and, in particular, to cause a cleaning effect via the pressure wave, e.g. on a contaminated container, a contaminated pipe or a steam boiler. Such a DWG comprises
a pressure chamber which can be filled with a working medium, in particular compressed air, via a pressure chamber inlet, with at least two pressure outlets located opposite each other;
an actuator chamber which can be filled with an actuator medium, in particular compressed air, via an actuator chamber inlet,
at least two actuator outlets opposite each other, which are connected to the pressure chamber by a passage;
a closure element in the pressure chamber which, in a closed position, closes the pressure chamber with respect to the pressure outlets and, in an open position, allows the working medium to flow out through the pressure outlets: The closure element in the pressure chamber is arranged at least partially between the passage and the pressure outlets. Advantageously, the closure element can be moved from the closed position to the open position by sliding it in an axial direction. The pressure outlets are advantageously arranged essentially radially outwards. In this context, “radial” is to be understood as any direction that is orthogonal to “axial”. “Essentially radial” shall in particular include deviations of up to 45°, in particular up to 30°, from the radial direction;
an actuator element in the actuator chamber which, in a closed position, closes the pressure chamber with respect to the actuator outlets and, in an open position, allows the working medium to flow out, in particular from the pressure chamber through the passage and the actuator outlets: The actuator element is arranged in the actuator chamber between the actuator chamber inlet and the passage. Advantageously, the actuator chamber inlet is sealed against the passage by the actuator element, which in particular has no passage opening. Advantageously, the actuator element can also be moved from the closed position to the open position by sliding it in the axial direction. The actuator outlets are advantageously arranged essentially radially outwards.

In operation with the working medium, the closure element can be moved from the closed position to the open position by moving the actuator element from the closed position to the open position. This can be achieved in particular by a “pneumatic actuator” comprising the actuator element and, advantageously, a second actuator element, as shown below.

### Pressure Chamber and Actuator Chamber

In an embodiment, the pressure chamber is essentially cylindrical and the closure element comprises a hollow cylinder that is open on one end face. An opposite end face of the hollow cylinder is essentially closed. However, the opposite end face can have a passage opening, in particular centrally arranged, through which an interior of the hollow cylinder can be filled with the working medium. In this case, an outer surface of the closure element must lie tightly and in particular gas-tightly against an inner surface of the pressure chamber. In particular, a seal is fitted between the outer surface of the closure element and the inner surface of the pressure chamber.

Advantageously, the closed end face of the closure element has an inner surface facing the interior that is, in particular, at least 5% smaller than an opposite outer surface. This has the effect that the closure element also remains in the closed position when the pressure chamber is closed, in particular when the actuator element is in the closed position. According to the general formula F=p·A, the difference in the area A between the outer surface and the inner surface of the closure element results in an effective force F on the closure element in the direction of the closed position, as the pressure p is the same on both sides in the stationary state.

If the passage is opened, in particular by moving the actuator element to the open position, working medium flows out through the passage and the actuator outlets. This causes the pressure on the outer surface of the closure element to drop rapidly. On the inner surface of the closure element, on the other hand, the pressure is reduced only slowly, namely as long as the closure element is in the closed position, only via the passage opening. As a result, an effective force acts on the closure element in the direction of the open position and the closure element is moved into the open position, whereby the pressure outlets of the pressure chamber are opened and the working medium, in particular from the interior of the closure element, escapes quickly. By “quickly” it is understood in particular that a half-value time of the pressure of the working medium in the pressure chamber after moving the actuator element into the open position is at most 10 ms, in particular at most 6 ms.

In general, the DWG generates a pressure wave both at the pressure outlets and at the actuator outlets. The arrangement described therefore effectively uses the entire volume, in particular both the partial volume on the outer surface of the closure element and the partial volume on the inner surface of the closure element, of the pressurized working medium in the pressure chamber to generate pressure waves with a cleaning effect. This achieves an increased cleaning effect.

In one embodiment, the pressure chamber is between 1.2 and 2 times, in particular between 1.4 and 1.7 times, as large as the interior of the closure element. This makes it easy to move the closure element between the closed and open positions. In particular, the interior of the closure element can have a volume of 1 to 2 liters and the pressure chamber a volume of one and a half to 3 liters. Furthermore, the closure element can have an outer diameter of 100 to 150 mm.

The passage opening in the closure element advantageously has a diameter of between 1 and 10 mm, in particular between 3 and 5 mm. Such a dimensioning enables easy movement of the closure element between the closed and open position and at the same time rapid filling of the pressure chamber with working medium, e.g. within a maximum of 5 s, in particular a maximum of 3 s.

In an embodiment, the pressure chamber can be filled with the working medium, in particular air, at a pressure of at least 100 bar, in particular at least 200 bar. In addition, the actuator chamber can advantageously be filled with the actuator medium, which is advantageously the same as the working medium, at a pressure of at least 10 bar. With such a dimensioning, the pressure chamber can, for example, be filled with a volume of air that has a volume of at least 150 liters, in particular at least 300 liters, at 1 bar. In particular, a speed of at least 15 m/s, especially at least 30 m/s, can be achieved when moving the closure element from the closed to the open position. This generates a sufficiently strong pressure wave so that even persistent dirt, e.g. caked-on soot or corrosion products such as rust, can be removed.

In addition, the actuator element, which closes the passage from the pressure chamber in its closed position, must be dimensioned depending on the pressure of the working medium and the pressure of the actuator medium so that it remains in the closed position when the pressure chamber and actuator chamber are full. The actuator element should only be moved to the open position when the pressure of the actuator medium is reduced. This is achieved by one end face of the actuator element, which is directed towards the passage, being smaller than an opposite end face, which is directed towards the actuator chamber inlet. The required ratio of the end faces can be calculated-depending on the pressures of the actuator medium and the working medium-using the general formula F=p·A.

### Pressure Outlets and Actuator Outlets

The fact that the at least two pressure outlets are arranged opposite each other, in other words symmetrically, in particular axially symmetrically on the DWG, has the effect that at least the radial components of the recoil forces on the DWG caused by the outflowing working medium cancel each other out. The same applies to the at least two actuator outlets, which are also located opposite each other on the DWG. In this way, the DWG can be operated hand-held. The DWG can therefore be designed as a mobile device that can be held manually, e.g. in a dirty boiler. Without a special arrangement of the outlets, the recoil forces of the outflowing working medium would make the DWG too large and mobile handling impossible.

In an embodiment, the total opening area of the pressure outlets is at least as large, in particular at least 20% larger, than the open end face of the hollow cylinder. This enables a rapid outflow of the working medium from the pressure chamber as soon as the closure element is in the open position, and thus a high outflow velocity and a strong pressure wave. Advantageously, the outflow velocity at a narrowest point, e.g. in the pressure outlets, is approximately Mach 1, so that the strongest possible pressure wave is achieved. In addition, the described dimensioning of the pressure outlets prevents the working medium from exerting excessive forces on components of the DWG, in particular adjacent to the pressure outlets, during outflow, which could lead to damage to the DWG, at least in the long term.

In an embodiment, the at least two pressure outlets on at least two sides of the pressure wave generator each comprise at least three outlet openings. The outlet openings can be designed with an essentially square cross-section. Such a design of the pressure outlets results in a strong pressure wave which is directed in an angular range of, for example, 90 degrees and thus achieves a good cleaning effect in this angular range.

The actuator outlets may also comprise one or more outlet openings, e.g. in the form of elongated outlet slots or, in particular, with a square cross-section. Here too, the shape of the outlets can be used to influence the strength and directional characteristic of the pressure wave generated.

Furthermore, it is advantageous that the at least two actuator outlets are essentially oriented in the same way as the at least two pressure outlets, in particular with a deviation of no more than 30 degrees.

In particular, the actuator outlets can be arranged at essentially the same angular position on the DWG as the pressure outlets. Such an arrangement has the effect that the pressure waves generated at the actuator outlets and at the pressure outlets are directed into the same angular range and reinforce each other in their cleaning effect.

In an embodiment, a total opening area of the actuator outlets or of the passage to the actuator outlets is smaller than the total opening area of the pressure outlets. In particular, the total opening area of the actuator outlets or the passage can be less than half as large as the total opening area of the pressure outlets. This has the advantage that the pressure of the working medium reduces more slowly via the actuator outlets than via the pressure outlets when the closure element is moved into the open position, so that the working medium remaining in the pressure chamber on the outside of the closure element acts as a gas spring and dampens the movement of the closure element. This in turn avoids a strong impact of the closure element on the inside of the pressure chamber and thus improves both the manageability and the service life of the DWG.

### Second Actuator Chamber

In an advantageous embodiment, the DWG additionally comprises
a second actuator chamber, which can be filled with the actuator medium via a second actuator chamber inlet, with at least two second actuator outlets located opposite one another: The second actuator chamber and the actuator chamber are connected by a second passage. This second passage corresponds advantageously to the actuator chamber inlet;
a second actuator element in the second actuator chamber which, in a closed position, closes the actuator chamber and the second actuator chamber with respect to the second actuator outlets and, in an open position, allows the actuator medium to flow out through the second passage and the second actuator outlets: The second actuator element is arranged in the second actuator chamber between the second actuator chamber inlet and the second passage.

For a simple and compact design, the actuator chamber can be filled with the actuator medium via the second actuator chamber and the second actuator chamber inlet.

Advantageously, the second actuator chamber and the second actuator element are cylindrical. The cylindrical shape generally has the advantage that the pressure forces are distributed without acting excessively on individual components or wall parts, and that at the same time the (second) actuator element in the (second) actuator chamber or the closure element in the pressure chamber can be displaced in the manner of a piston.

Furthermore, the second actuator element can have a passage opening, in particular a central one. The actuator chamber can also be filled with actuator medium from the second actuator chamber inlet via this passage opening. Advantageously, the second actuator element—similar in principle to the closure element—is shaped such that an end face aligned with the actuator chamber is smaller, in particular at least 5% smaller, than an end face aligned with the second actuator chamber inlet. This in turn has the effect, as described above in connection with the closing element, that the second actuator element remains in the closed position when the actuator chamber and the second actuator chamber are filled and, thus, closes the second actuator outlets. As a result, the actuator element and the closure element also remain in the closed position and the pressure chamber can be filled with working medium.

In an advantageous embodiment, the DWG further comprises a controllable drain valve, in particular for the second actuator chamber inlet, for triggering the draining of actuator medium from the actuator chamber. Advantageously, the drain valve comprises a solenoid valve. By opening the drain valve, the above-mentioned “pneumatic actuator” is actuated as follows: The pressure in the second actuator chamber decreases as actuator medium flows out through the drain valve. As a result, an effective force acts on the second actuator element in the direction of the open position and moves it into the open position so that the second actuator outlets are released. The actuator medium now also flows out of the actuator chamber quickly, in particular via the second actuator outlets. As a result, the pressurized working medium exerts an effective force on the actuator element in the direction of the open position. The actuator element is moved into the open position and releases the actuator outlets so that working medium flows out there, the closure element moves into the open position as described above and pressure waves are generated.

### Further Aspects of the DWG

It is unavoidable that the flow of the working medium when flowing out of the pressure outlets also has an axial component of the flow velocity in addition to the radial component, especially while the closing element is moving into the open position. As a result, the recoil force on the DWG also includes an axial component, which is not compensated for by the clever arrangement of the pressure outlets described above and causes an undesirable impact on the operator, particularly under manual operation.

To minimize this recoil, in an advantageous embodiment at least one projection is provided on an outer side of the DWG adjacent to the at least two pressure outlets in the direction of the end face of the DWG. At the same time, the pressure outlets should also be arranged in a part of the pressure chamber facing the end face of the DWG and, in particular, the closure element should be in a position close to the end face in its closed position, while it is in a position remote from the end face in the open position. Such an arrangement of the pressure outlets leads to an axial component of the flow velocity of the outflowing working medium in the direction of the end face. The protrusions are advantageously arranged in such a way that they influence and, in particular, deflect the flow of the working medium flowing out through the pressure outlets. When the flow hits the projections, a force acts on the DWG which at least partially compensates for the axial component of the recoil force, in particular by at least 50%. Suitable protrusions are, for example, ribs, which protrude at least 1 cm and advantageously run parallel to the end faces. In an advantageous embodiment, the at least one projection is designed as a ring running around adjacent to the at least two pressure outlets.

In this way, a DWG can be provided that can be held by hand during operation, in other words it can be operated hand-held. Such manual maneuverability facilitates, accelerates and improves the cleaning of dirty containers, as the DWG can be held at the points to be cleaned without great effort, e.g. by repeated assembly.

The weight of the DWG naturally also plays an important role here. Advantageously, the DWG has a weight of no more than 12 kg, in particular no more than 7 kg. This can be achieved by making key components of the DWG, in particular the pressure chamber, the actuator chamber, the second actuator chamber, the closure element, the actuator element and/or the second actuator element, from aluminum. A low weight in turn improves handling.

### System for Generating a Pressure Wave

A further aspect of the invention relates to a system for generating a pressure wave. The system comprises the DWG described above and a lance to the distal end of which the DWG is attached. At the proximal end of the lance, the system can be held by a user and controlled from there. The lance comprises a first supply line for working medium and a second supply line for actuator medium. In addition, the lance advantageously comprises a control line for controlling the drain valve, e.g. an electrical line in the case of a solenoid valve.

Such a system makes it possible to clean dirty containers, in particular pipes or boilers, even in remote locations without the user having to enter the container themselves. For this purpose, the lance may be at least 3 m long, in particular at least 5 m long. In particular, such a system makes it possible to clean contaminated containers during operation, e.g. in the case of a power plant or generator, without shutting it down.

For the latter application in particular, the DWG or system must be designed to withstand temperatures of several hundred degrees Celsius, in particular at least 900 degrees celsius. The following embodiment is advantageous for this purpose: The lance comprises a multi-chambered hollow profile. An outer chamber of the hollow profile is designed to supply cooling water and/or cooling air for the DWG to the distal end of the lance. At the distal end, the lance can in particular have outlet openings that are arranged in such a way that the cooling water trickles or flows over the DWG during operation and cools it. Furthermore, the first and second supply lines and, in particular, the control line run in an inner chamber of the hollow profile. In this way, the supply lines and the control line are also protected from the high temperatures during operation, which enables cleaning at high temperatures, especially when the power plant is in operation.

In a further embodiment, the system comprises a camera that is attached to the pressure wave generator, in particular to the end face of the pressure wave generator, and is set up to inspect an area surrounding the pressure wave generator. An infrared camera (IR camera) has proven to be particularly suitable for inspecting contaminated areas. The camera can speed up and/or improve the cleaning of soiled containers, as soiled areas can be better recognized and the DWG can be better aligned to these areas.

Advantageously, the system also comprises at least one storage bottle to which the first and second supply lines are connected. The at least one storage bottle can, for example, contain a total volume of 200 to 300 liters of the working or actuator medium. In practice, the at least one storage bottle can be filled with working or actuator medium using a compressor up to a pressure of over 300 bar, e.g. 330 bar. A compressor with a capacity of at least 500 to 800 liters/min at 330 bar has proven to be particularly practical for this purpose.

### Method for Generating a Pressure Wave

A further aspect of the invention relates to a method for generating a pressure wave, in particular for cleaning contaminated containers. In particular, the method is carried out using the DWG described above and comprises the following steps:
(a) Filling the actuator chamber with a gaseous actuator medium at a pressure above 10 bar, in particular below 50 bar;
(b) Filling the pressure chamber with a gaseous working medium at a pressure of over 100 bar, in particular over 200 bar;
(c) Moving the actuator element from the closed position to the open position, thereby moving the closure element from the closed position to the open position and thereby releasing the pressurized working medium from the pressure chamber through the pressure outlets and the actuator outlets: As explained above, the rapid release due to the high pressure of the working medium in the pressure chamber creates a pressure wave at the pressure outlets and the actuator outlets, which has a good cleaning effect.

For a good cleaning effect, it is advantageous that the pressurized working medium is released from the pressure chamber in step (c) with a half-value time of less than 10 ms, in particular less than 6 ms. Such half-value times can be achieved with a DWG with the dimensions described above.

In an embodiment, the working medium and in particular the actuator medium is air. In particular, the pressure chamber can be filled with a volume of air that has a volume of at least 150 liters, in particular at least 300 liters, at 1 bar.

Furthermore, in an embodiment with a second actuator chamber, it is advantageous that the actuator chamber is filled in step (a) via the second actuator chamber and the passage opening in the second actuator element. This avoids a separate inlet for the actuator chamber and enables a compact design. The pressure chamber, on the other hand, advantageously has its own pressure chamber inlet.

In addition, the movement of the actuator element in step (c) is effected in an embodiment by draining actuator medium from the actuator chamber through the actuator chamber inlet and in particular by draining actuator medium from the second actuator chamber via the second actuator chamber inlet, in particular by opening the drain valve, see the above description of the “pneumatic actuator”.

In continuous operation when cleaning a contaminated container, the DWG is usually not only actuated once, i.e. it does not only generate a single pressure wave, but “shoots” at regular intervals. Advantageously, the method therefore comprises repeating steps (a), (b) and (c) with a pressure wave interval of at most 10 s, in particular at most 5 s. Theoretically, therefore, at least 6, in particular at least 12, “shots”, i.e. pressure waves, are generated per minute. In particular, the method for cleaning the container additionally comprises moving the DWG to a next location to be cleaned, in particular by hand.

### Use of the DWG

The features of the DWG or the system for generating a pressure wave described above are meant to be also disclosed in connection with said method and vice versa. Furthermore, the invention relates to a use of the DWG, the system or the method for cleaning a contaminated vessel, tube or steam boiler. Such vessels, pipes and steam boilers are typically part of a power plant, e.g. a coal-fired power plant, waste-fired power plant, biomass-fired power plant or gas turbine power plant.

When used in a coal-fired power plant, the DWG will therefore primarily clean the surfaces of the container from soiling caused by combustion products, e.g. soot. As described, this can even be done while the power plant is in operation, i.e. while hot flue gases are circulating in the container.

When used in a gas turbine combined cycle power plant, the DWG will primarily remove rust from the finned tube surfaces of the downstream steam boiler. The rust is formed as a corrosion product during the further utilization of the residual heat contained in the flue gas.

If the environment of the DWG is rather cool, in particular below 100 degrees celsius, e.g. with downstream boilers in a gas turbine power plant, an arrangement with a wire rope hoist is also conceivable instead of the system with lance described above. In this case, the DWG is attached to a rope hoist, which is configured such that the DWG can reach and clean the entire surface of a tube bundle in the tank. In particular, the position of the DWG may be automatically controlled via the rope hoist and a computer-implemented control system and adapted to the respective container.

### BRIEF DESCRIPTION OF THE DRAWINGS

Further embodiments, advantages and applications of the invention are apparent from the dependent claims and from the following description of the figures. These show:

FIG. 1 a schematic drawing of a pressure wave generator (DWG) according to an embodiment of the invention;

FIGS. 2 and 3 schematic drawings of systems for generating a pressure wave according to embodiments of the invention in use.

### DETAILED DESCRIPTION

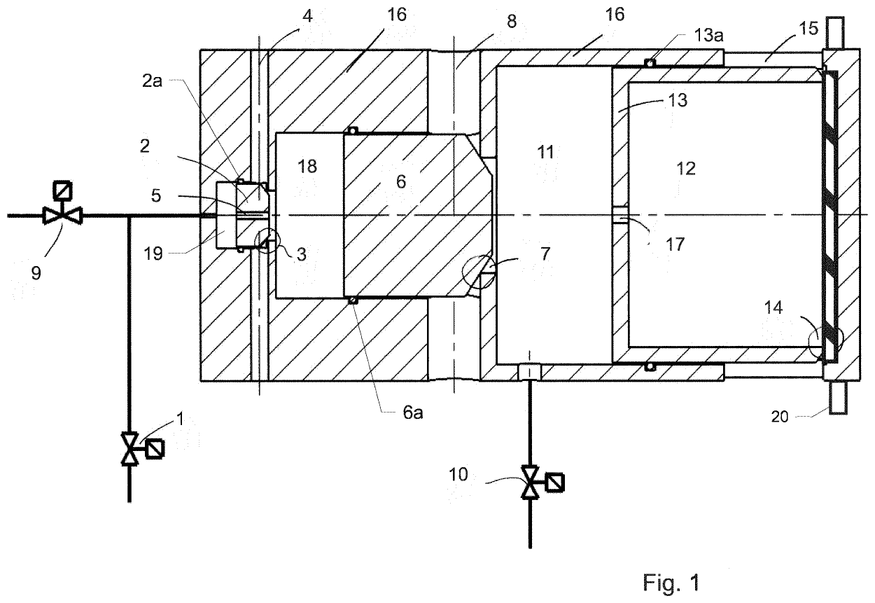

The structure of a DWG is shown schematically in FIG. 1. A housing 16, which is advantageously made of aluminum for weight reasons, encloses a pressure chamber, which consists of the interior 12 and the gas spring chamber 11, an actuator chamber 18 and a second actuator chamber 19.

In the pressure chamber 11, 12, which has a cylindrical shape, there is a hollow cylinder 13, which acts as a closure element as described above. The hollow cylinder 13 encloses the interior 12 and, in its closed position (as shown in FIG. 1), closes pressure outlets 15 from the pressure chamber 11, 12 to the surroundings of the DWG. The hollow cylinder may have an outer diameter of approx. 0.1 m, for example. The volume of the inner chamber 12 can be e.g. approx. 1 liter, the volume of the gas spring chamber 11 e.g. approx. 0.6 liter. In order to prevent working medium from flowing out of the gas spring chamber 11 through the pressure outlets 15, a seal 13a, e.g. an O-ring with Teflon, is fitted between the hollow cylinder 13 and the inner wall of the housing 16.

For optimum sealing, the housing 16 can generally have a sealing layer 14, in particular made of Teflon, on the end face of the DWG, against which the hollow cylinder 13 is pressed in the closed position. The pressure chamber can be filled with a pressurized working medium, e.g. air, via a valve-controlled supply line 10. The pressure of the working medium in the pressure chamber may be over 200 bar in order to generate a powerful pressure wave with a good cleaning effect. When the pressure chamber is closed, this pressure acts both in the gas spring chamber 11 and in the interior 12, as it is equalized via a passage opening 17 in the hollow cylinder 13 and a state of equilibrium is established.

An actuator element 6 is located in the actuator chamber 18, which also has a cylindrical shape. In its closed position (as shown in FIG. 1), the actuator element 6 closes a passage 7 between the pressure chamber, in particular the gas spring chamber 11, and the actuator outlets 8. The actuator element 6 seals against the inner wall of the actuator chamber 18. For this purpose, a sealing ring 6a, e.g. comprising Teflon, can be inserted into the inner wall of the actuator chamber, for example.

In the second actuator chamber 19, there is a second actuator element 2, which (like the hollow cylinder 13) has a through-hole 5. In its closed position (as shown in FIG. 1), the second actuator element 2 closes a passage 3 between actuator chamber 18 and second actuator outlets 4. The second actuator element 2 is also sealed against the inner wall of the housing by means of a seal 2a, e.g. an O-ring with Teflon.

The second actuator chamber 19 and the actuator chamber 18 are filled with actuator medium, e.g. air, under pressure from a valve-controlled supply line 1 via the through-hole 5. A release valve 9, which is also fitted at the inlet to the second actuator chamber 19, is closed. The pressure in the actuator chamber 18 is typically significantly lower, in particular by approximately one order of magnitude, than the pressure in the pressure chamber. In particular, the actuator chamber 18 is filled with air at a pressure of between 8 and 25 bar, e.g. approx. 20 bar.

The supply valves 1, 10 and the drain valve 9 are advantageously solenoid valves that can be controlled via an electrical pulse. The control system is advantageously designed as a computer or hardware-implemented control system so that the valves open and close automatically during operation.

It is advantageous for the drain valve 9 to be located close to the second actuator chamber 19 in order to enable the actuator medium to be drained quickly. In particular, the drain valve should be located no more than 1 m away from the second actuator chamber 19. For reasons of robustness and compact design, it is advisable for the drain valve 9 to be integrated in the housing 16. The supply valves 1, 10, on the other hand, can be further away from the housing 16, e.g. at the end of the lance or more than 1 m or more than 3 m away from the housing 16. In particular, if the DWG is attached to a lance, as described above, the supply valves 1, 10 may be located in a supply and control unit which e.g. also contains pressurized gas cylinders and is connected upstream of the lance. This has the advantage that the system consisting of lance and DWG, which is intended to be mobile, has a lower weight and can therefore be held by hand.

A “firing cycle”, in which a pressure wave is generated during operation of the DWG, proceeds as follows:
1. The supply valve 1 for the actuator medium is opened. The actuator pressure rises in front of the second actuator element 2 and presses it into its seat in the passage 3, closing the second actuator outlets 4. Valves 9 and 10 remain closed during this phase.
2. The actuator medium now flows through the small through-hole 5 to the actuator element 6 and presses it into the seat in passage 7, i.e. in the closed position, whereby the actuator outlets 8 are closed.
3. The power supply valve 10 is opened and the gas spring chamber 11 and the interior 12 via the small passage opening 17 in the hollow cylinder or piston 13 are filled with working medium. The gas spring piston surface is larger than the piston inner surface, the gas spring force therefore presses the piston 13 towards the end face into the soft seal 14, i.e. into the closed position, and thus closes the radial pressure outlets 15. The DWG is now charged.
4. The supply valves 1 and 10 are closed.
5. The drain valve 9 is opened: The drive pressure behind the second actuator element 2 drops and the actuator element is opened by the now higher pressure force on the passage side 7. The drive pressure of the actuator element 6 escapes via the second actuator outlets 4 and the pressure of the working medium in the gas spring chamber 11 pushes the actuator element 6 open (open position) and releases the radial actuator openings 8.
6. The gas spring air escapes via the actuator openings 8 and relieves the gas spring 11. The internal piston pressure in the interior 12 is now greater than the gas spring pressure in the gas spring chamber 11, and the piston 13 is moved backwards, i.e. into the open position, by the differential force and opened at high speed. As a result, the working medium now escapes from the piston 13 radially outwards via the pressure outlets 15.

When the working medium escapes rapidly from the gas spring chamber 11 through the actuator outlets 8 and from the interior 12 through the pressure outlets 15, strong pressure waves are created in the surrounding gas. The pressure waves propagate in the environment and clean the surfaces from contamination when they hit them.

To ensure that the DWG can be operated hand-held, some precautions must be taken as described above, as the recoil of the outflowing working medium would otherwise tear the DWG out of a user's hand. On the one hand, the pressure outlets 15 are arranged opposite each other on the housing 16; the same applies to the actuator outlets 8.

On the other hand, it is advantageous that projections 20, e.g. in the form of ribs or a circumferential ring, are attached to the outside of the housing 16 next to the pressure outlets 15. Outflowing gas with an axial component of the flow hits the projections 20. As explained above, the axial recoil exerted by the outflowing working medium on the pressure chamber 11, 12 and the piston 13 and the oppositely directed impact of the working medium on the projections 20 at least partially compensate each other. This in turn enables easier handling of the DWG.

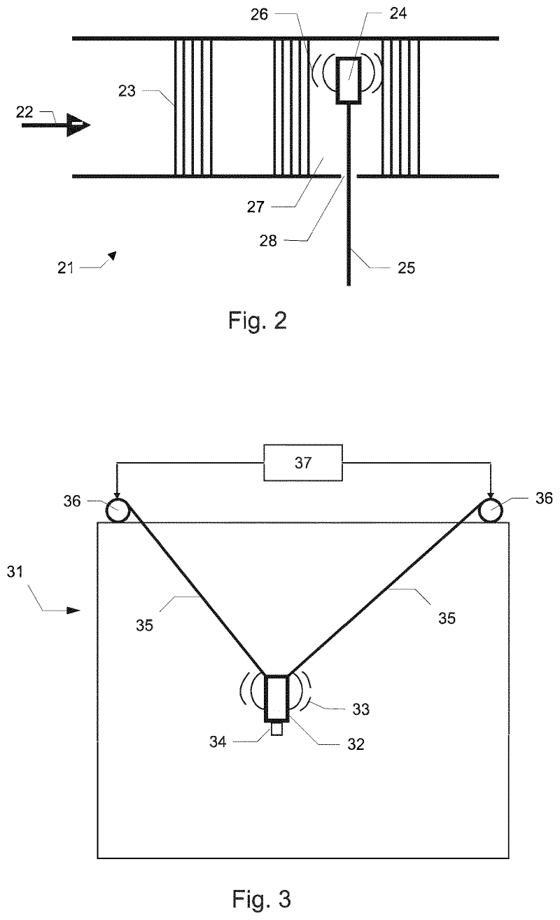

FIG. 2 shows a system consisting of DWG 24 and lance 25, on which the DWG 24 is mounted, in use in a steam boiler. Tube bundles 23 with a large number of heat exchanger tubes are installed in the convective pass 21 of the steam boiler, covering the entire flow cross-section of the boiler. Hot flue gas 22 flows through the tube bundles 23, known as “bundles” for short, past the heat exchanger tubes and transfers its heat to the tubes. As the flue gas 22 often carries combustion products with it, which settle or condense on the bundles 23, soiling occurs there, e.g. in the form of soot and caking. Between every two bundles 23 there is an intermediate space 27, called an alley, which is accessible via a boiler door 28. The side length of the, e.g. square, boiler cross-section is typically between 3 and 25 m.

A DWG 24 according to the invention can be used to remove this contamination. For this purpose, the DWG 24 can be introduced into the alley 27 through the boiler door 28 with the aid of the lance 25. Advantageously, the lance 25 is over 3 m long and up to 12 m long, for example, in order to be able to clean larger boilers with a side length of up to 25 m that are accessible from both sides. In the alley 27, the DWG 24 generates strong pressure waves 26, ideally directed at the bundles 23 and the soiling. The optimized manageability described above allows the lance 25 to be held by hand even in “shooting mode”. Furthermore, in one embodiment of the system with water cooling in particular, it is not even necessary to switch off the hot gas flow 22. The steam boiler 21 and bundles 23 can therefore be cleaned during operation.

FIG. 3 shows an alternative installation of a DWG 32 in a vessel in the form of a boiler 31, e.g. a downstream steam boiler in a gas-fired combined cycle power plant. The DWG 32 is suspended from ropes 35 in the boiler 31. At the same time, the supply lines for the working and actuator medium and the control line may also run along the ropes 35. The position of the DWG 32 can be controlled via motor-driven rollers 36, over which the ropes 35 run. The control of the position of the DWG 32 and the “shots”, i.e. the generation of the pressure waves 33, is preferably carried out automatically, e.g. via a computer-implemented control system 37.

Another advantageous feature is a camera 34, which is attached to the DWG 32. This allows particularly dirty areas to be detected and the cleaning success to be estimated. It is also conceivable to control the position and the “shots” of the DWG 32 in real time via the computer-implemented control 37 depending on the images taken by the camera 34.

While preferred embodiments of the invention are described in the present application, it should be noted that the invention is not limited thereto and may be practiced in other ways within the scope of the following claims.

1. A pressure wave generator for generating a pressure wave, comprising
a pressure chamber, which can be filled with a working medium via a pressure chamber inlet, with at least two pressure outlets located opposite one another,
an actuator chamber which can be filled with an actuator medium via an actuator chamber inlet,
at least two actuator outlets located opposite each other, which are connected to the pressure chamber by a passage,
a closure element in the pressure chamber which, in a closed position, closes the pressure chamber with respect to the pressure outlets and, in an open position, allows the working medium to flow out through the pressure outlets,
wherein the closure element is arranged in the pressure chamber at least partially between the passage and the pressure outlets,
an actuator element in the actuator chamber which, in a closed position, closes the pressure chamber with respect to the actuator outlets and, in an open position, allows the working medium to flow out through the passage and the actuator outlets,
wherein, during operation with the working medium, the closure element can be moved from the closed position to the open position by moving the actuator element from the closed position to the open position.

2. The pressure wave generator according to claim 1,
wherein the closure element and in particular also the actuator element can be moved from the closed position to the open position by displacement in the axial direction,
wherein the pressure outlets and the actuator outlets are arranged essentially radially outwards.

3. The pressure wave generator according to claim 1,
wherein the pressure chamber is substantially cylindrical and the closure element comprises a hollow cylinder which is open at one end face,
wherein an opposite end face of the hollow cylinder is substantially closed and has a passage opening, in particular centrally arranged, through which an interior of the hollow cylinder can be filled with the working medium.

4. The pressure wave generator according to claim 3,
wherein the closed end face of the closure element has an inner surface facing the interior which is, in particular at least 5%, smaller than an opposite outer surface.

5. The pressure wave generator according to claim 3,
wherein a total opening area of the pressure outlets is at least as large, in particular at least 20% larger, than the open end face of the hollow cylinder.

6. The pressure wave generator according to claim 1,
wherein the pressure chamber is between 1.2 and 2 times, in particular between 1.4 and 1.7 times, as large as an or, respectively, the interior of the closure element,
in particular wherein the interior of the closure element has a volume of 1 to 2 liters and the pressure chamber has a volume of one and a half to 3 liters, and/or in particular wherein the closure element has an external diameter of 100 to 150 mm.

7. The pressure wave generator according to claim 1,
wherein the pressure chamber is fillable with the working medium at a pressure of at least 100 bar, in particular at least 200 bar,
in particular wherein the actuator chamber is fillable with the actuator medium un-der a pressure of at least 10 bar.

8. The pressure wave generator according to claim 1,
wherein the at least two actuator outlets are essentially oriented in the same way as the at least two pressure outlets,
in particular wherein the actuator outlets are arranged at substantially the same angular position on the pressure wave generator as the pressure outlets.

9. The pressure wave generator according to claim 1,
wherein a total opening area of the actuator outlets or of the passage is smaller, in particular less than half as large, than the total opening area of the pressure outlets.

10. The pressure wave generator according to claim 1,
wherein at least one projection is provided on an outer side of the pressure wave generator adjacent to the at least two pressure outlets in the direction of the end face of the pressure wave generator,
in particular wherein the projections are arranged such that they influence and in particular deflect a flow of the working medium flowing out through the pressure outlets.

11. The pressure wave generator according to claim 1, further comprising
a second actuator chamber, which can be filled with the actuator medium via a second actuator chamber inlet, with at least two second actuator outlets located opposite one another,
wherein the second actuator chamber and the actuator chamber are connected by a second passage, in particular by the actuator chamber inlet,
a second actuator element in the second actuator chamber which, in a closed position, closes the actuator chamber and the second actuator chamber with respect to the second actuator outlets and, in an open position, allows the actuator medium to flow out through the second passage and the second actuator outlets,
wherein the second actuator element is arranged in the second actuator chamber between the second actuator chamber inlet and the second passage,
wherein the actuator chamber can be filled with the actuator medium via the second actuator chamber and the second actuator chamber inlet.

12. The pressure wave generator according to claim 11,
wherein the second actuator chamber and the second actuator element are cylindrical and wherein the second actuator element has a passage opening, in particular arranged centrally.

13. The pressure wave generator according to claim 1,
wherein the actuator chamber inlet is sealed against the passage by the actuator element, which in particular has no passage opening.

14. The pressure wave generator according to claim 1, comprising
a controllable drain valve, in particular for the second actuator chamber inlet, for triggering the draining of actuator medium from the actuator chamber and in particular from the second actuator chamber,
in particular wherein the drain valve comprises a solenoid valve.

15. The pressure wave generator according to claim 1, which is such that it can be operated handheld,
in particular wherein the pressure wave generator has a weight of at most 12 kg, in particular at most 7 kg.

16. A system for generating a pressure wave comprising
the pressure wave generator according to claim 1,
a lance, at a distal end of which the pressure wave generator is attached, wherein the lance comprises a first supply line for working medium and a second supply line for actuator medium,
in particular wherein the lance comprises a control line for actuating the drain valve.

17. The system according to claim 16,
wherein the lance comprises a multi-chambered hollow profile,
wherein an outer chamber of the hollow profile is arranged for a supply of cooling water and/or cooling air for the pressure wave generator to the distal end of the lance,
wherein the first and second supply lines and in particular the control line run in an inner chamber of the hollow profile.

18. The system according to claim 16, comprising
a camera, in particular an IR camera, which is attached to the pressure wave generator, in particular to the end face of the pressure wave generator, and is set up for inspecting an environment of the pressure wave generator.

19. A method of generating a pressure wave with the pressure wave generator according to claim 1 or the system for generating a pressure wave comprising
the pressure wave generator,
a lance, at a distal end of which the pressure wave generator is attached,
wherein the lance comprises a first supply line for working medium and a second supply line for actuator medium,
in particular wherein the lance comprises a control line for actuating the drain valve, comprising the steps of
(a) filling the actuator chamber with a gaseous actuator medium at a pressure of above 10 bar, in particular below 50 bar;
(b) filling the pressure chamber with a gaseous working medium at a pressure of over 100 bar, in particular over 200 bar;
(c) moving the actuator element from the closed position to the open position, there-by moving the closure element from the closed position to the open position and thereby releasing the pressurized working medium from the pressure chamber through the pressure outlets and the actuator outlets.

20. The method according to claim 19,
wherein the pressurized working medium is released from the pressure chamber in step (c) with a half-value time of less than 10 ms, in particular less than 6 ms.

21. The method according to claim 19,
wherein the actuator chamber is filled in step (a) via the second actuator chamber and the passage opening in the second actuator element.

22. The method according to claim 19,
wherein the working medium and in particular the actuator medium is air,
in particular wherein the pressure chamber is filled with a quantity of air which has a volume of at least 150 liters, in particular at least 300 liters, at 1 bar.

23. The method according to claim 19,
wherein the movement of the actuator element in step (c) is effected by draining actuator medium from the actuator chamber through the actuator chamber inlet and in particular by draining actuator medium from the second actuator chamber via the second actuator chamber inlet, in particular by opening the drain valve.

24. The method according to claim 19,
additionally comprising repeating steps (a), (b) and (c) with a pressure wave interval of at most 10 s, in particular at most 5 s.

25. Use of the pressure wave generator according to claim 1, the system for generating a pressure wave comprising
the pressure wave generator,
a lance, at a distal end of which the pressure wave generator is attached,
wherein the lance comprises a first supply line for working medium and a second supply line for actuator medium,
in particular wherein the lance comprises a control line for actuating the drain valve or the method of generating a pressure wave with the pressure wave generator, comprising the steps of
(a) filling the actuator chamber with a gaseous actuator medium at a pressure of above 10 bar, in particular below 50 bar;
(b) filling the pressure chamber with a gaseous working medium at a pressure of over 100 bar, in particular over 200 bar;
(c) moving the actuator element from the closed position to the open position, there-by moving the closure element from the closed position to the open position and thereby releasing the pressurized working medium from the pressure chamber through the pressure outlets and the actuator outlets for cleaning a fouled vessel, pipe or steam boiler.
